(19) United States
(12) Patent Application Publication
(10) Pub. No.: US 2017/0364116 A1
(43) Pub. Date: Dec. 21, 2017

(54) DISCHARGE CIRCUIT FOR DIODE REVERSE LEAKAGE CURRENT

(71) Applicant: ASIAN POWER DEVICES INC., Taoyuan (TW)

(72) Inventors: TSUNG-LIANG HUNG, Taoyuan (TW); YEU-TORNG YAU, Taoyuan (TW); PING-HSUN CHU, Taoyuan (TW)

(21) Appl. No.: 15/345,516

(22) Filed: Nov. 8, 2016

(30) Foreign Application Priority Data
Jun. 21, 2016 (TW) 105119515

(51) Int. Cl. G05F 3/16

(52) U.S. Cl. CPC G05F 3/16

(57) ABSTRACT

A discharge circuit for a diode reverse leakage current includes an input positive terminal, an input negative terminal, an output positive terminal coupled to the input positive terminal, an output negative terminal coupled to the input negative terminal, a diode and a current source device. The diode has an anode terminal coupled to the input positive terminal and a cathode terminal coupled to the output positive terminal. The current source device has a first end coupled to the anode terminal of the diode and a second end coupled between the input and output negative terminals. The voltage difference across the current source device is reduced by less than about 1 V when input voltage is switched off. The current source device continues to operate when the input voltage is normal. As P=VI, the loss is proportional to the input voltage, therefore achieving the objective of low loss.

### FIELD OF THE INVENTION

The present invention relates to a discharge circuit for a diode reverse leakage current, and more particularly to a discharge circuit capable of reducing loss.

### BACKGROUND OF THE INVENTION

In the DC/DC converter design, the input terminal may meet the specification of “Reverse Reverse Protection”; therefore, an active switch such as a BJT, MOSFET or even a relay is used to perform input turn off for protecting. However, to achieve this protection, the additional cost is quite high. So in the design of the premise of the economy, usually the Schottky diode is used to achieve the aforementioned protection. Schottky diode has some advantages such as low bias voltage, easy to use and quick response; therefore, Schottky diode is widely used in the input-terminal reverse protection. As shown in FIG. 1, by reversely coupling the two diodes D1 and D2 with the terminals A and B, respectively, the output terminals C and D can be completely isolated thereby achieving the protection.

However, the approach of FIG. 1 has a drawback. Because the Schottky diode has a certain reverse leakage current I_{R} which is usually tens to hundreds of uA, so when voltages across the terminals C and D exists, the reverse leakage current I_{R} would continue to charge across the terminals A and B to maintain at a high voltage if the input voltage is removed, which is not allowed in some applications.

To solve the above problem, a discharge resistor may be added between the terminals A and B to form a current path for the reverse leakage current I_{R} as shown in FIG. 2. Because the voltage across the terminals A and B is V_{AB}=I_{R}×R1, therefore the voltage across the terminals A and B can be limited within a certain range. However, in some applications, it is necessary to limit the voltage across the terminals A and B to a very low voltage level (less than 1 to 2 V), so a low resistance value of the resistor R1, such as several KΩ to 10KΩ, is required to limit the voltage across the terminals A and B. But when the circuit is in the normal operation, a high voltage may be across the terminals A and B; therefore, when the resistor R1 is continuously coupled between the terminals A and B, an unnecessary but great power loss up to 1 W or more may occur across the resistor R1 according to P=V2/R.

### SUMMARY OF THE INVENTION

In order to achieve the aforementioned or other objectives, the present invention provides a discharge circuit for a diode reverse leakage current. The discharge circuit includes an input positive terminal, an input negative terminal, an output positive terminal, an output negative terminal, a first diode and a current source device. The output positive terminal is coupled to the input positive terminal. The output negative terminal is coupled to the input negative terminal. The first diode has an anode terminal coupled to the input positive terminal and a cathode terminal coupled to the output positive terminal. The current source device has a first end coupled to the anode terminal of the first diode and a second end coupled between the input negative terminal and the output negative terminal. When the input voltage is turned off, since the current of the current source device may be larger than the diode reverse leakage current, the voltage difference across the current source device may be reduced by less than about 1 V. The current source device continues to operate when the input voltage is in normal operation, and the loss would be proportional to the input voltage due to P=VI and the objective of low loss is achieved accordingly.

The present invention further provides a discharge circuit for a diode reverse leakage current. The discharge circuit includes an input positive terminal, an input negative terminal, an output positive terminal, an output negative terminal, a first diode and a current source device. The output positive terminal is coupled to the input positive terminal. The output negative terminal is coupled to the input negative terminal. The first diode has an anode terminal coupled to the output negative terminal and a cathode terminal coupled to the input negative terminal. The current source device has a first end coupled between the input positive terminal and the output positive terminal and a second end coupled to the cathode terminal of the first diode.

### BRIEF DESCRIPTION OF THE DRAWING

The present disclosure will become more readily apparent to those ordinarily skilled in the art after reviewing the following detailed description and accompanying drawings, in which:

FIG. 1 is a schematic circuit diagram in prior art;

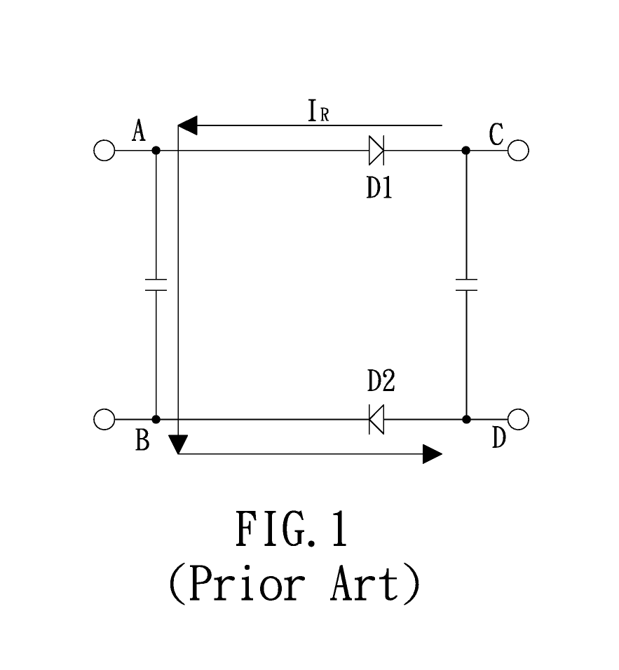

FIG. 2 is another schematic circuit diagram in prior art;

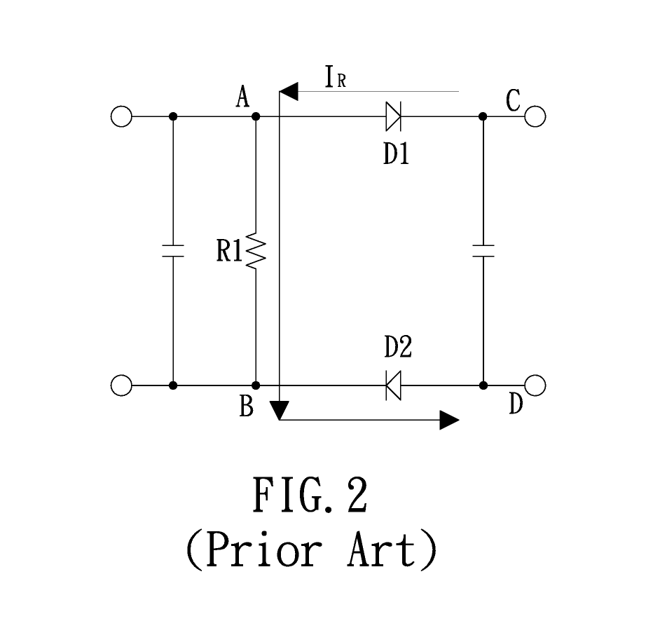

FIG. 3 is a schematic circuit diagram of the first embodiment of the present invention;

FIG. 4 is a schematic circuit diagram of the second embodiment of the present invention;

FIG. 5 is a schematic circuit diagram of the third embodiment of the present invention;

FIG. 6 is a schematic circuit diagram of the fourth embodiment of the present invention;

FIG. 7 is a schematic circuit diagram of the fifth embodiment of the present invention;

FIG. 8 is a schematic circuit diagram of the sixth embodiment of the present invention;

FIG. 9 is a schematic circuit diagram of an implementation of the sixth embodiment;

FIG. 10 is a schematic circuit diagram of another implementation of the sixth embodiment;

FIG. 11 is a schematic circuit diagram of the seventh embodiment of the present invention; and

FIG. 12 is a schematic circuit diagram of the eighth embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

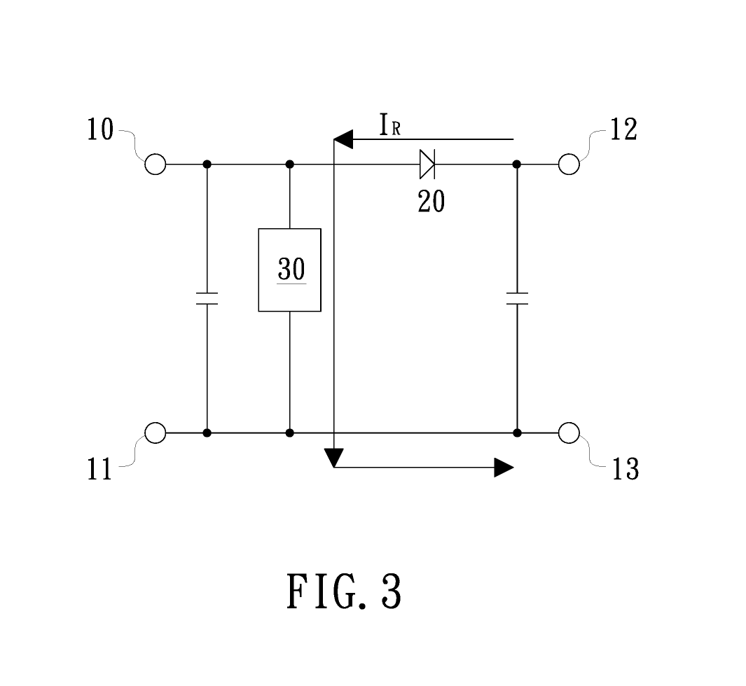

Referring to FIG. 3, which is a schematic circuit diagram of the first embodiment of the present invention. As shown in FIG. 3, the present invention provides a discharge circuit for a diode reverse leakage current, which includes an input positive terminal 10, an input negative terminal 11, an output positive terminal 12, an output negative terminal 13, a first diode 20 and a current source device 30. The output positive terminal 12 is coupled with the input positive terminal 10; and the output negative terminal 13 is coupled with the input negative terminal 11. The anode terminal of the first diode 20 is coupled to the input positive terminal 10 and the cathode terminal thereof is coupled to the output positive terminal 12. A first end of the current source device 30 is coupled to the anode terminal of the first diode 20 and a second end thereof is coupled between the input negative terminal 11 and the output negative terminal 13. The current source device 30 may be a constant current diode or other equivalent element, and the present invention is not limited thereto.

In the present embodiment, the current source device 30 is disposed between the input positive terminal 10 and the input negative terminal 11. When the input voltage is turned off, since the current of the current source device 30 may be larger than the reverse leakage current I_{R} flowing through the first diode 20, the voltage difference across the current source device 30 may be reduced by less than about 1 V. The current source device 30 continues to operate when the input voltage is in normal operation, and the loss would be proportional to the input voltage due to P=VI; so that when the voltage difference V is at a relatively low level, the loss resulted by the current source device 30 differs from that resulted by a resistor in prior art.

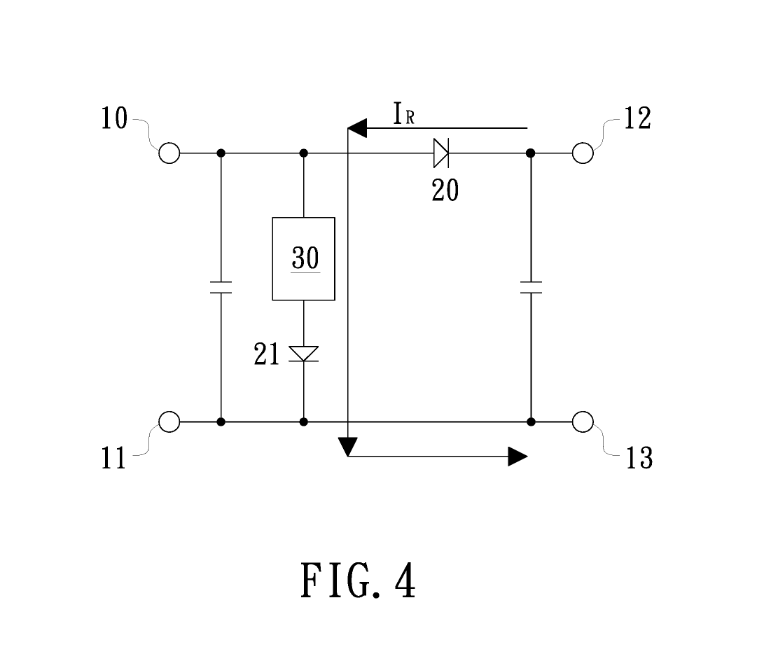

Please refer to FIG. 4, which is a schematic circuit diagram of the second embodiment of the present invention. As shown in FIG. 4, the second embodiment differs from the first embodiment of FIG. 3 in that the discharge circuit further includes a second diode 21. The anode terminal of the second diode 21 is coupled to the second end of the current source device 30 and the cathode terminal thereof is coupled between the input negative terminal 11 and the output negative terminal 13. The second diode 21 is mainly for protecting the current source device 30 from damage.

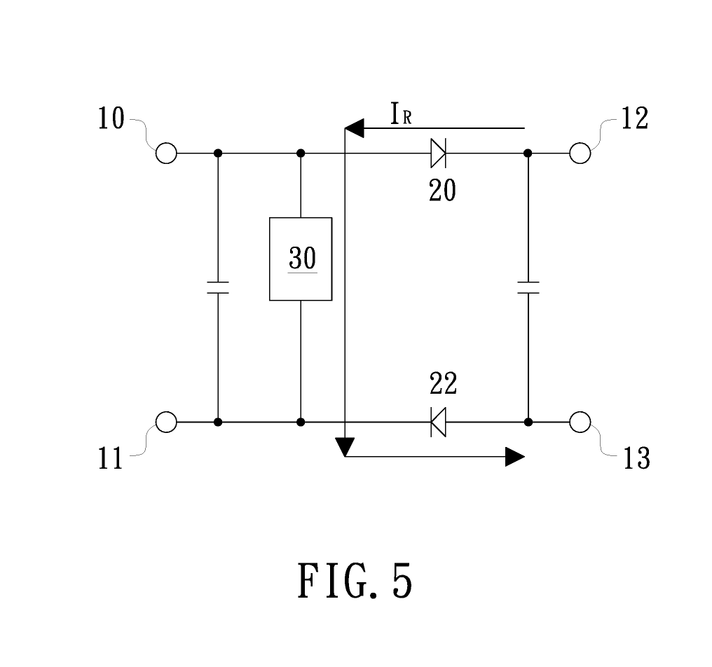

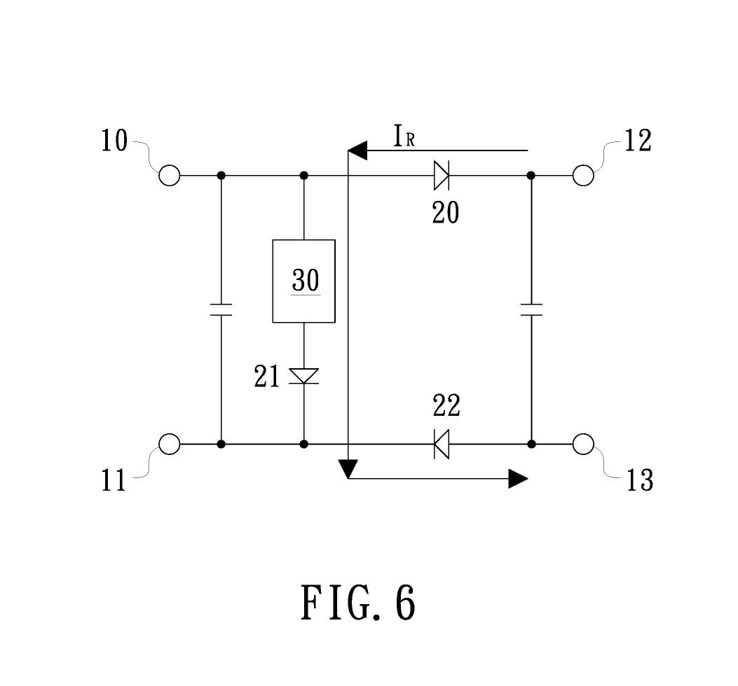

Please refer to FIGS. 5 and 6, which are schematic circuit diagrams of the third and fourth embodiments of the present invention, respectively. As shown in FIGS. 5 and 6, the third and fourth embodiments differ from the previous first and second embodiments of respective FIGS. 3 and 4 in that they each further include a third diode 22. The anode terminal of the third diode 22 is coupled to the output negative terminal 13 and the cathode terminal thereof is coupled to the input negative terminal 11. The third diode 22 is mainly for protecting the integrated circuit from damage. In the third and fourth embodiments as shown in respective FIGS. 5 and 6, the second end of the current source device 30 and the cathode terminal of the second diode 21 are coupled to the cathode terminal of the third diode 22. However, in other embodiments, the second end of the current source device 30 and the cathode terminal of the second diode 21 may be coupled to the anode terminal of the third diode 22, and the present invention is not limited thereto.

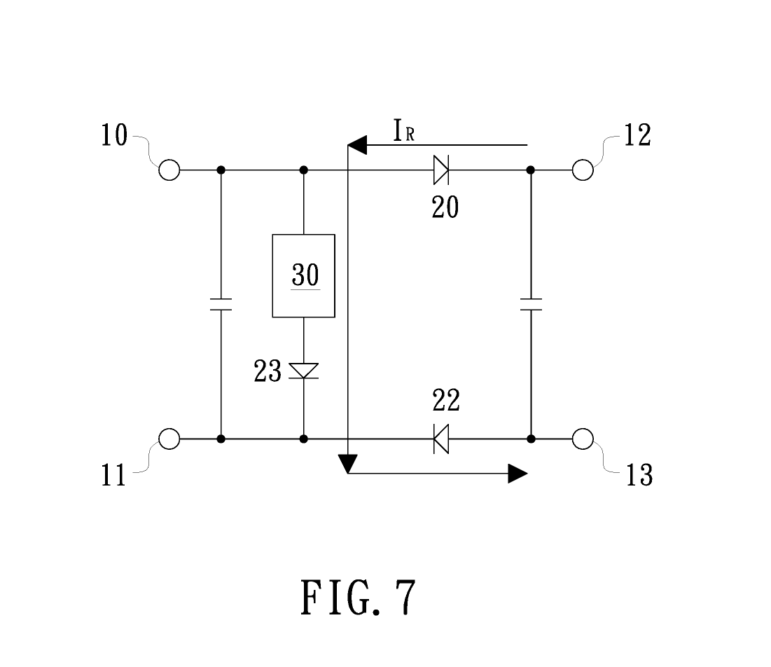

Please refer to FIG. 7, which is a schematic circuit diagram of the fifth embodiment of the present invention. As shown in FIG. 7, the seventh embodiment differs from the previous second embodiment of FIG. 4 in that the second diode 21 is replaced by a light-emitting element 23. The first end of the light-emitting element 23 is coupled to the second end of the current source device 30 and the second end of the light-emitting element 23 is coupled between the input negative terminal 11 and the output negative terminal 13. The light-emitting element 23 may be an LED. Because needing to be in a constant current state to emit light, the LED may be used to indicate whether or not the current source device 30 is in operation in a protective function state.

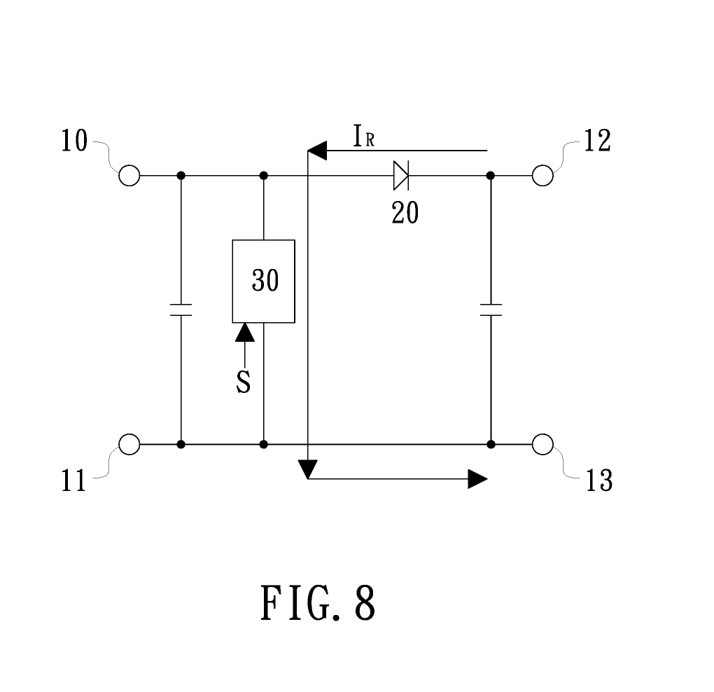

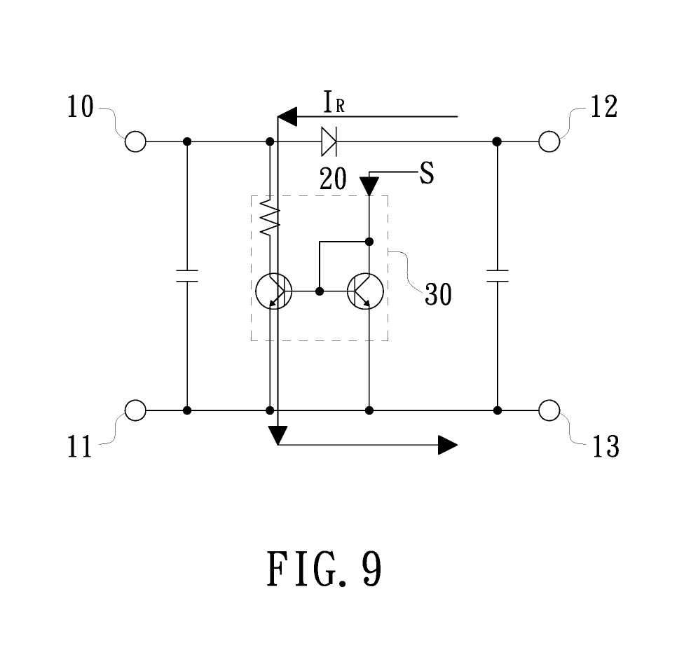

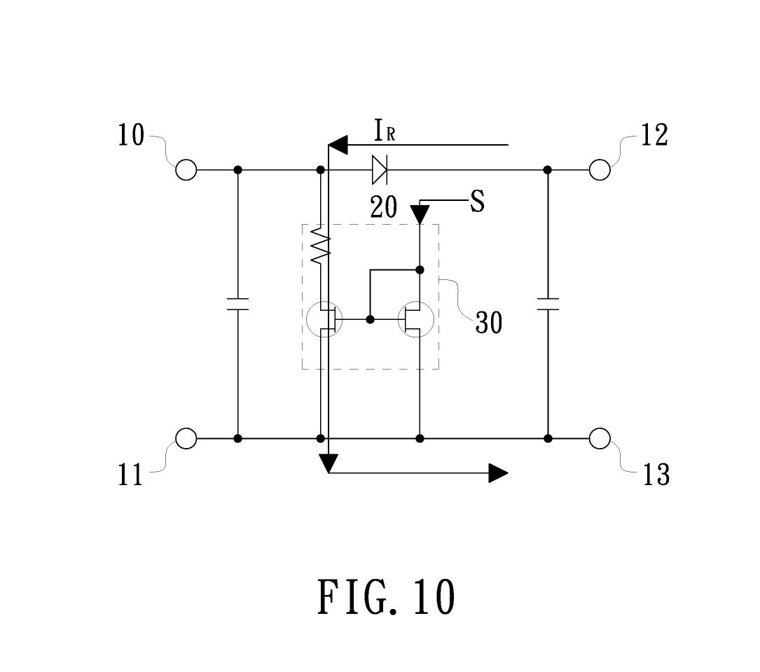

Please refer to FIG. 8, which is a schematic circuit diagram of the sixth embodiment of the present invention. As shown in FIG. 8, the sixth embodiment differs from the previous embodiments in that the current source device 30 may be an adjustable circuit; wherein the current of the current source device 30 may be regulated by an external signal S. In FIG. 8, the adjustable circuit is a current mirror. FIG. 9 is a schematic circuit diagram of an implementation of the sixth embodiment. As shown in FIG. 9, the current mirror is composed of a double BJT element. FIG. 10 is a schematic circuit diagram of another implementation of the sixth embodiment. As shown in FIG. 10, the current mirror is composed of a double FET element. The aforementioned implementations are for an exemplary purpose only, and the present invention is not limited thereto.

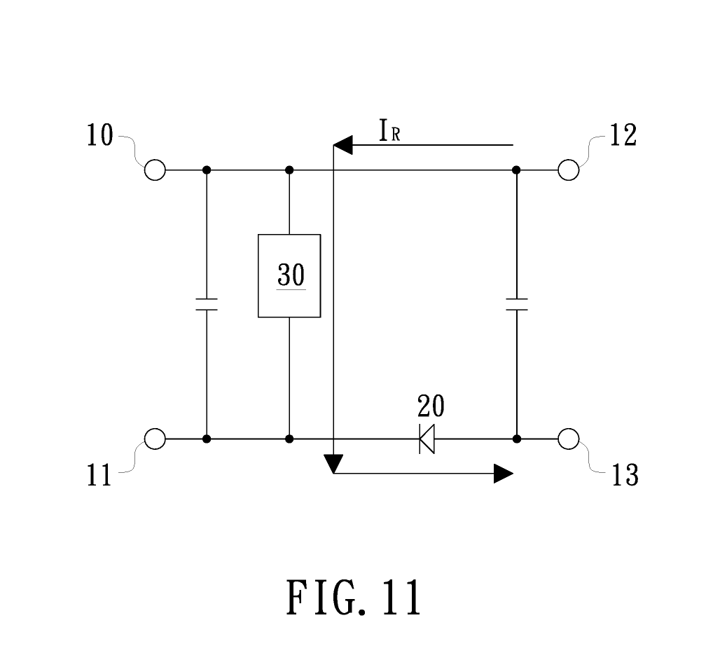

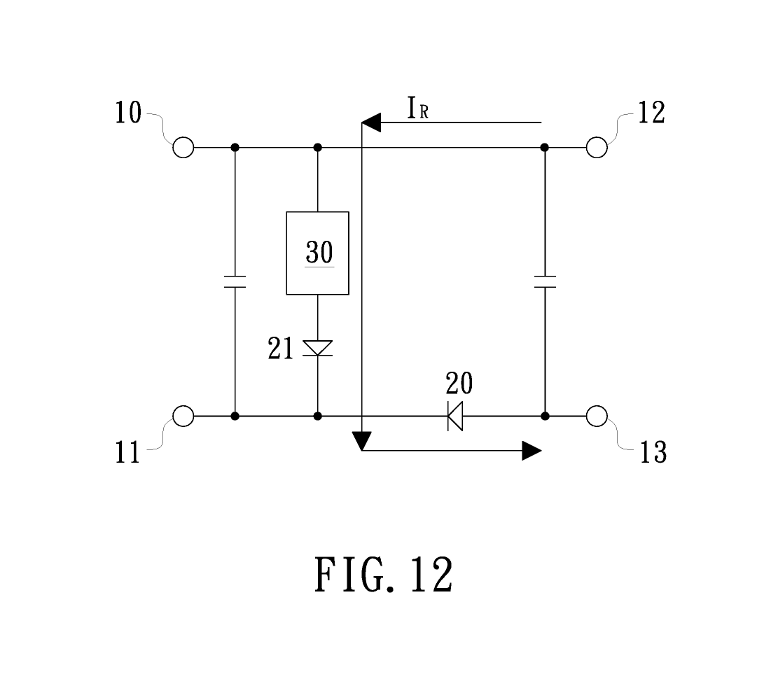

Please refer to FIGS. 11 and 12, which are schematic circuit diagrams of the seventh and eighth embodiments of the present invention, respectively. As shown in FIGS. 11 and 12, the seventh and eighth embodiments differ from the previous first and second embodiments in the position of the first diode 20, and the other functions are completely identical. As shown in FIGS. 11 and 12, the anode terminal of the first diode 20 is coupled to the output negative terminal 13 and the cathode terminal thereof is coupled to the input negative terminal 11, thereby achieving the same effect as in the first and second embodiments.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A discharge circuit for a diode reverse leakage current, comprising:
an input positive terminal;
an input negative terminal;
an output positive terminal, coupled to the input positive terminal;
an output negative terminal, coupled to the input negative terminal;
a first diode, having an anode terminal coupled to the input positive terminal and a cathode terminal coupled to the output positive terminal; and
a current source device, having a first end coupled to the anode terminal of the first diode and a second end coupled between the input negative terminal and the output negative terminal.

2. The discharge circuit according to claim 1, further comprising a third diode having an anode terminal coupled to the output negative terminal and a cathode terminal coupled to the input negative terminal, wherein the second end of the current source device is coupled to the anode terminal or the cathode terminal of the third diode.

3. The discharge circuit according to claim 2, wherein the current source device is a constant current diode.

4. The discharge circuit according to claim 1, further comprising a second diode having an anode terminal coupled to the second end of the current source device and a cathode terminal coupled between the input negative terminal and the output negative terminal.

5. The discharge circuit according to claim 4, further comprising a third diode having an anode terminal coupled to the output negative terminal and a cathode terminal coupled to the input negative terminal, wherein the cathode terminal of the second diode is coupled to the anode terminal or the cathode terminal of the third diode.

6. The discharge circuit according to claim 5, wherein the current source device is a constant current diode.

7. The discharge circuit according to claim 1, further comprising a light-emitting element having a first end coupled to the second end of the current source device and a second end coupled between the input negative terminal and the output negative terminal.

8. The discharge circuit according to claim 1, wherein the current source device is an adjustable circuit configured to regulate a current thereof according to an external signal.

9. The discharge circuit according to claim 8, wherein the adjustable circuit is a current mirror circuit.

10. A discharge circuit for a diode reverse leakage current, comprising:
an input positive terminal;
an input negative terminal;
an output positive terminal, coupled to the input positive terminal;
an output negative terminal, coupled to the input negative terminal;
a first diode, having an anode terminal coupled to the output negative terminal and a cathode terminal coupled to the input negative terminal; and
a current source device, having a first end coupled between the input positive terminal and the output positive terminal and a second end coupled to the cathode terminal of the first diode.

11. The discharge circuit according to claim 10, further comprising a second diode having an anode terminal coupled to the second end of the current source device and a cathode terminal coupled to the cathode terminal of the second diode.
